(19) United States
(12) Patent Application Publication
(10) Pub. No.: US 2018/0357992 A1
(43) Pub. Date: Dec. 13, 2018

(54) Dynamic Audio Signal Processing System

(71) Applicant: Dennis G. Cronin, Scottsdale, AZ (US)

(72) Inventor: Dennis G. Cronin, Scottsdale, AZ (US)

(21) Appl. No.: 16/005,895

(22) Filed: Jun. 12, 2018

Related U.S. Application Data
(60) Provisional application No. 62/518,141, filed on Jun. 12, 2017.

(51) Int. Cl. G10H 1/00; G10H 3/18

(52) U.S. Cl. CPC G10H 1/0091; G10H 3/186; G10H 2210/076; G10H 2210/311; G10H 2210/095; G10H 2210/315

(57) ABSTRACT

A dynamic audio signal processing system for dynamically and continuously applying effects to an audio signal in real-time based on detected audio signal attributes. The dynamic audio signal processing system generally includes a signal processor including an input for receiving an audio signal, such as from an instrument. The signal processor may include an input analyzer adapted to detect one or more attributes of the audio signal continuously and in real-time. The signal processor may also include one or more signal conditioners in parallel with the input analyzer; each of the signal conditioners being adapted to dynamically apply one or more effects to the audio signal based on the one or more attributes detected by the input analyzer. The signal processor may include a selector for selecting which, if any, of the signal conditioners to apply effects to the audio signal based on detected attributes.

### CROSS REFERENCE TO RELATED APPLICATIONS

I hereby claim benefit under Title 35, United States Code, Section 119(e) of U.S. provisional patent application Ser. No. 62/518,141 filed Jun. 12, 2017. The 62/518,141 application is currently pending. The 62/518,141 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a dynamic audio signal processing system which dynamically applies effects to an audio signal based on signal attributes detected continuously in real-time.

### Related Art

Any discussion of the related art throughout the specification should in no way be considered as an admission that such related art is widely known or forms part of common general knowledge in the field.

Effects have been applied to audio signals for many years to create dynamic soundscapes. It has become very common for various effects to be applied to a wide range of audio signals, such as vocals or instrumentation (guitars, pianos, etc.). A wide range of effects have been used in the past, ranging from simple level changes to complex effects such as delay, reverb, and the like.

Typically, effects are applied manually either by the musician during recording or by sound engineers after recording has been completed, such as in a digital audio workstation. In the past, both the type of effects applied and the various characteristics of the applied effects have been manually adjusted. This can necessitate the use of various clumsy input mechanisms such as foot pedals or controllers. Further, differences in how various individuals hear and process sounds can impact the objective application of effects to audio signals.

### SUMMARY

An example embodiment is directed to a dynamic audio signal processing system. The dynamic audio signal processing system includes a signal processor including an input for receiving an audio signal, such as from an instrument. The signal processor may include an input analyzer adapted to detect one or more attributes of the audio signal continuously and in real-time. The signal processor may also include one or more signal conditioners in parallel with the input analyzer; each of the signal conditioners being adapted to dynamically apply one or more effects to the audio signal based on the one or more attributes detected by the input analyzer. The signal processor may include a selector for selecting which, if any, of the signal conditioners to apply effects to the audio signal based on detected attributes. In this manner, a performance may be dynamically configured based on input signal attributes continuously and in real-time.

A musical performance, for example from an electric guitar, can be analyzed and attributes extracted to allow automatic and dynamic configuration of downstream musical effects. The effects chain can adapt or morph between settings in response to the performance without requiring a foot switch or other manual input. The human might have higher level input into the process by selecting a patch or palette or broader processing combinations, but then the remainder of the processing may occur without human intervention above and beyond normal performance on the instrument, leveraging the advanced signal processing capabilities of modern processors. This results in an interactive performance with the effects analysis and selection becoming a part of the performance.

Above and beyond controlling facets of the effects beyond the capabilities of the performer, the system may contribute random variations in the effects configuration to allow the performer to incorporate a degree of uniqueness in each performance. The system may also respond in predictable and deterministic ways which allow the performance to indicate the types of effects change desired.

There has thus been outlined, rather broadly, some of the embodiments of the dynamic audio signal processing system in order that the detailed description thereof may be better understood, and in order that the present contribution to the art may be better appreciated. There are additional embodiments of the dynamic audio signal processing system that will be described hereinafter and that will form the subject matter of the claims appended hereto. In this respect, before explaining at least one embodiment of the dynamic audio signal processing system in detail, it is to be understood that the dynamic audio signal processing system is not limited in its application to the details of construction or to the arrangements of the components set forth in the following description or illustrated in the drawings. The dynamic audio signal processing system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a dynamic audio signal processing system in accordance with an example embodiment.

FIG. 2 is a block diagram of a dynamic audio signal processing system in accordance with an example embodiment.

FIG. 3 is a block diagram of a dynamic audio signal processing system in accordance with an example embodiment.

FIG. 4 is a block diagram illustrating multiple signal conditioners of a dynamic audio signal processing system in accordance with an example embodiment.

FIG. 5 is a block diagram illustrating multiple input analyzers of a dynamic audio signal processing system in accordance with an example embodiment.

FIG. 6 is a block diagram illustrating exemplary signal conditioners of a dynamic audio signal processing system in accordance with an example embodiment.

FIG. 7 is a block diagram illustrating exemplary signal conditioners of a dynamic audio signal processing system in accordance with an example embodiment.

FIG. 8 is a block diagram illustrating exemplary signal conditioners of a dynamic audio signal processing system in accordance with an example embodiment.

FIG. 9 is a flowchart illustrating an exemplary method of use of a dynamic audio signal processing system in accordance with an example embodiment.

FIG. 10 is a flowchart illustrating an exemplary method of attribute detection by an input analyzer of a dynamic audio signal processing system in accordance with an example embodiment.

FIG. 11 is a flowchart illustrating an exemplary method of signal conditioner application based on attribute detection of a dynamic audio signal processing system in accordance with an example embodiment.

FIG. 12 is a flowchart illustrating an exemplary method of transient detection of a dynamic audio signal processing system in accordance with an example embodiment.

FIG. 13 is a flowchart illustrating an exemplary method of level detection of a dynamic audio signal processing system in accordance with an example embodiment.

FIG. 14 is a flowchart illustrating an exemplary method of density and polyphonic detection of a dynamic audio signal processing system in accordance with an example embodiment.

FIG. 15 is a flowchart illustrating an exemplary method of pitch shifting of a dynamic audio signal processing system in accordance with an example embodiment.

FIG. 16 is a flowchart illustrating an exemplary method of filtering and limiting an audio signal of a dynamic audio signal processing system in accordance with an example embodiment.

FIG. 17 is a flowchart illustrating an exemplary method of filtering and compressing an audio signal of a dynamic audio signal processing system in accordance with an example embodiment.

### DETAILED DESCRIPTION

### A. Overview

An example dynamic audio signal processing system 10 generally comprises a signal processor 20 including an input 12 for receiving an audio signal, such as from an instrument 17. The signal processor 20 may include an input analyzer 30 adapted to detect one or more attributes of the audio signal continuously and in real-time. The signal processor 20 may also include one or more signal conditioners 40 in parallel with the input analyzer 30; each of the signal conditioners 40 being adapted to dynamically apply one or more effects to the audio signal based on the one or more attributes detected by the input analyzer 30. The signal processor 20 may include a selector 60 for selecting which, if any, of the signal conditioners 40 to apply effects to the audio signal based on detected attributes. In this manner, a performance may be dynamically configured based on input signal attributes continuously and in real-time.

An exemplary embodiment of the audio signal processing system 10 may comprise an input 12 adapted to receive an audio signal and a signal processor 20 adapted to process the audio signal. An input analyzer 30 may analyze the audio signal, wherein the input analyzer 30 is adapted to continuously detect one or more attributes of the audio signal in real-time. A signal conditioner 40 may automatically apply one or more effects to the audio signal based on the one or more attributes detected by the input analyzer 30.

The input analyzer 30 may comprise a transient detector 31 for detecting transients in the audio signal. The transient detector 31 may also be adapted to detect transient timing of the audio signal. The input analyzer 30 may comprise a level detector 32 for detecting changes in a signal level of the audio signal. The input analyzer 30 may comprise an articulation detector 33 for detecting an articulation of the audio signal; with the articulation detector 33 being adapted to detect whether the audio signal is legato or staccato. The input analyzer 30 may comprise a tempo detector 34 for detecting a tempo of the audio signal. The input analyzer 30 may comprise a polyphonic detector 35 for detecting whether the audio signal comprises single note phrases or chordal passages. The input analyzer 30 may comprise a density detector 36 for detecting a note density of the audio signal.

The effects applied by the signal conditioner 40 may be selected from the group consisting of a phase shifter 45, a flange 46, a chorus 47, a delay 48, an echo 49, a reverb 51, a pitch changer 52, a rotating speaker 53, and a distortion 54. It should be appreciated that the preceding listing of exemplary effects is merely exemplary and not in any manner meant to be limiting in scope. A selector 60 may be provided which is adapted to select which of the one or more effects to be applied to the audio signal.

Another exemplary embodiment of a dynamic audio signal processing system 10 may comprise an instrument 17 for producing an audio signal and a signal processor 20 including an input 12 adapted to receive the audio signal. An input analyzer 30 may analyze the audio signal, wherein the input analyzer is adapted to continuously detect one or more attributes of the audio signal in real-time. A signal conditioner 40 may automatically apply one or more effects to the audio signal based on the one or more attributes detected by the input analyzer 30. A selector 60 may be adapted to select which of the effects to be applied to the audio signal. An output device such as a speaker 16, recording device, or the like may be connected to an output 13 of the signal processor 20 may be utilized for playing the audio signal after the effects have been applied to the audio signal. The input analyzer 30 may comprise a transient detector 31 for detecting transients in the audio signal and a level detector 32 for detecting changes in a signal level of the audio signal. The effects may be selected from a group consisting of a phase shifter 45, a flange 46, a chorus 47, a delay 48, an echo 49, a reverb 51, a pitch changer 52, a rotating speaker 53, and a distortion 54. The input analyzer 30 may comprise an articulation detector 33 for detecting an articulation of the audio signal, a polyphonic detector 35 for detecting whether the audio signal comprises single note phrases or chordal passages, and a density detector 36 for detecting a note density of the audio signal.

An exemplary method of processing an audio signal may comprise the steps of receiving an audio signal by an input 12 of a signal processor 20, analyzing the audio signal by an input analyzer 30 of the signal processor 20 continuously in real-time to detect one or more attributes of the audio signal, and applying one or more effects to the audio signal by one or more signal conditioners 40 of the signal processor 20 continuously in real-time based on the one or more attributes detected by the input analyzer 30. The one or more effects may be selected from the group consisting of a phase shifter 45, a flange 46, a chorus 47, a delay 48, an echo 49, a reverb 51, a pitch change 52, a rotating speaker 53, and a distortion 54. The one or more attributes may be selected from the group consisting of transients, transient timing, signal level, articulation, tempo, and note density. A further step may comprise modifying the one or more effects applied to the audio signal by the signal processor 20 continuously in real-time based on the one or more attributes detected by the input analyzer 30. The input analyzer 30 may be selected from the group consisting of a transient detector 31, a level detector 32, an articulation detector 33, a tempo detector 34, a polyphonic detector 35, and a density detector 36. The preceding list is in no way exhaustive and is not meant to be limiting. Exemplary additional detection functions may include tessitura (high versus low range) detection, harmonic balance detection, or the like.

### B. Signal Processor

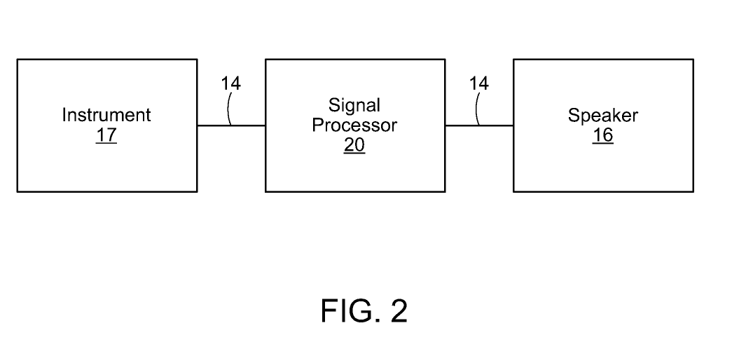

As best shown in FIGS. 2-8, a signal processor 20 is utilized to control the various operations of the dynamic audio signal processing system 10. The signal processor 20 will generally comprise a processor such as a microprocessor which is adapted to be programmed to perform the various methods described herein for automatically and continuously processing an audio signal in real-time.

It should be appreciated that the type of processor used for the signal processor 20 may vary in different embodiments and to suit different applications. The signal processor 20 could be a single-core processor or a multi-core processor. An exemplary signal processor 20 for use with the dynamic audio signal processing system 10 is the ARM series of embedded processors.

It should be appreciated that the scope of the present invention should not be construed as limited to any particular type of signal processor 20, as any number of processors currently available or in development could be utilized to perform the various functions described herein. In some embodiments, multiple processors could be communicatively interconnected to perform the functions of the signal processor 20.

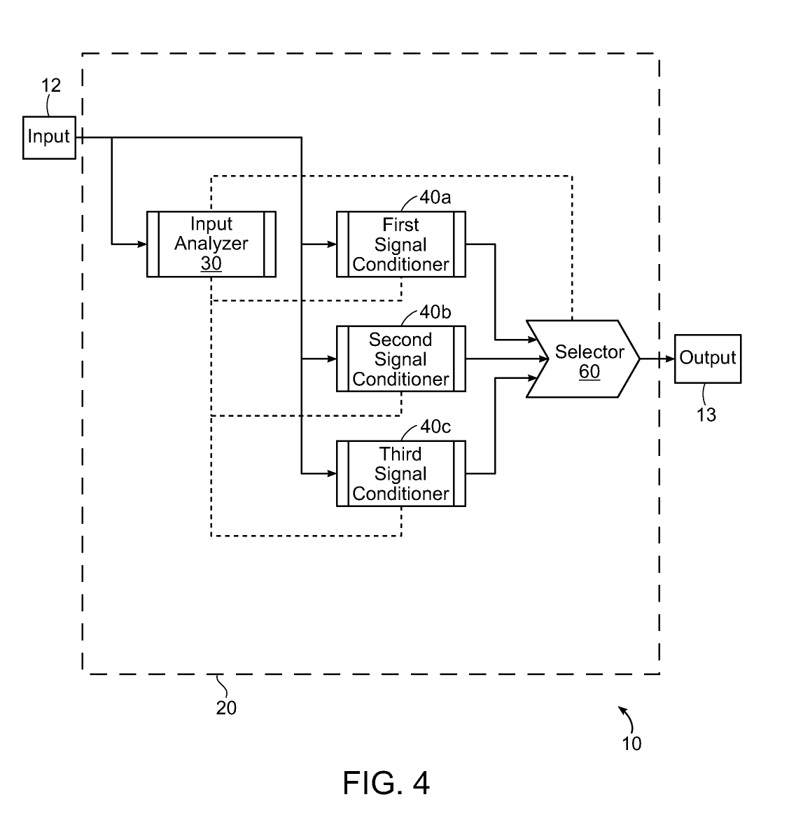

As shown in FIG. 4, the signal processor 20 will generally include an input analyzer 30, one or more signal conditioners 40, and a selector 60. While the figures illustrate a single signal processor 20 which incorporates the input analyzer 30, signal conditioners 40, and selector 60, it should be appreciated that multiple signal processors 20 may be utilized. For example, a first signal processor 20 could be utilized for the input analyzer 30 and a second signal processor 20 could be utilized for the signal conditioners 40. As a further example, different signal conditioners 40 could each be supported by its own signal processor 20 in certain embodiments.

The signal processor 20 may be adapted to receive the audio signal, such as from an instrument 17. The signal processor 20 may be adapted to analyze various attributes of the audio signal in real-time, such as transients, transient timing, signal level, articulation, tempo, types of notes (single note phrases or chordal passages), note density, and the like. It should be appreciated that the above list of attributes capable of being detected by the signal processor 20 is not meant to be exhaustive, but is merely an exemplary list and thus should not be construed as limiting in scope.

The signal processor 20 may be adapted to apply various effects to the audio signal based on the attributes detected. A wide range of effects may be supported, such as but not limited to phase shifting 45, flange 46, chorus 47, delay 48, echo 49, reverberation (reverb) 51, pitch change 52, rotating speaker 53, distortion 54, and the like. The effects may be arranged in different groups, such that the signal processor 20 may select different groupings of effects to be applied automatically to the audio signal in real-time. In some embodiments, a single effect may stand alone and thus the signal processor 20 may select a single effect to be applied automatically to the audio signal in real-time.

The signal processor 20 may include a selector 60 adapted to select which (if any) of the effects to be applied to the audio signal based on the detected attributes of the audio signal. The selector 60 will preferably operate continuously so as to dynamically adjust the effects being applied to the audio signal in response to the continuously-detected attributes of the audio signal.

The signal processor 20 may include an input 12 for receiving the audio signal, such as from an instrument or a microphone. If the source of the signal is analog, such as from a microphone, the signal processor 20 may include an analog-to-digital converter which will convert the audio signal from the analog input from the microphone to a digital signal for analysis and processing. In other embodiments, the source of the signal may be digital and thus an analog-to-digital converter may be unnecessary.

The signal processor 20 may include an output 13 for outputting the audio signal after effects processing. The output 13 may be connected to a speaker 16 such as an amplifier which is commonly used with instruments. In other embodiments, the output 13 may be connected to recording devices or digital effects processors for further processing.

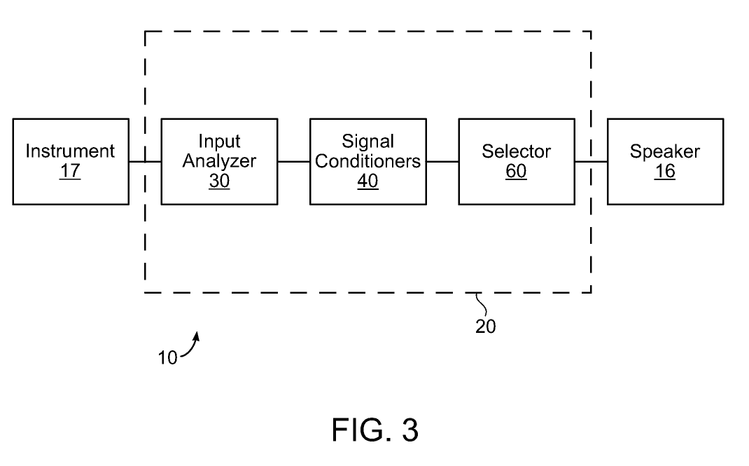

Generally, as shown in FIG. 3, the input 12 will be connected to an instrument 17 and the output 13 will be connected to a speaker 16, recording device, or the like. The figures illustrate cords 14 being used to interconnect both the input 12 with the instrument 17 and the output 13 with the speaker 16 or other output device. In some embodiments, cords 14 may be omitted and instead wireless transmission used to input or output audio signals to/from the signal processor 20.

### C. Input Analyzer

As best shown in FIGS. 2-8, the signal processor 20 may include an input analyzer 30. The input analyzer 30 may be adapted to continuously analyze an audio signal to determine various attributes of the audio signal. Although the figures and description herein lists an exemplary listing of attributes which may be detected by the input analyzer 30, it should be appreciated that this listing is merely by way of example and should not be construed as limiting in scope.

Using the input analyzer 30, the tonal makeup of the audio signal may be examined to detect the formant and to determine the tone settings of the instrument 17. The effects may be configured appropriately for brighter playing versus muted filtering for lighter tones in the instrument 17.

The input analyzer 30 will generally be incorporated into the signal processor 20. For example, the signal processor 20 may be programmed to perform the various functions of the input analyzer 30. In other embodiments, the input analyzer 30 could be on its own processor and thus not be incorporated fully into the signal processor 20 shown in the figures.

The input analyzer 30 preferably operates continuously in real-time to analyze the audio signal as it is fed into the input 12 of the signal processor 20. Real-time, continuous analysis allows for smoother effects processing preventing obvious pauses or clicks when applying effects or signal modification with the signal conditioner 40.

A wide range of attributes may be detected by the input analyzer 30. For example and without limitation, the input analyzer 30 may be adapted to detect transients, transient timing, levels, articulation, polyphonic characteristics, and/or density and to estimate tempo. Various other attributes of the audio signal may be analyzed by the input analyzer 30 in different embodiments.

The input analyzer 30 may be adapted to analyze one or more of the attributes. Depending on the type of signal conditioners 40 available, certain attributes of the audio signal may not be necessary. The figures illustrate exemplary combinations of attributes to be detected. Any combination of such attributes may be supported by the input analyzer 30 to suit different applications.

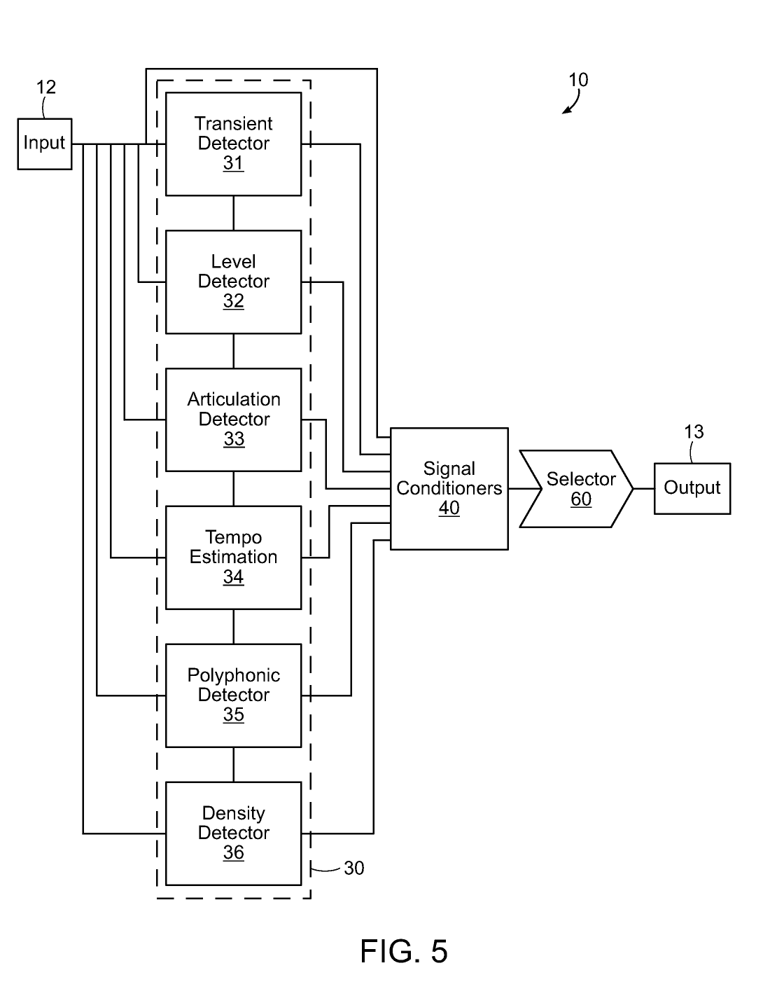

As shown in FIG. 5, the input analyzer 30 may incorporate one or more detectors 31, 32, 33, 34, 35, 36 for detecting various attributes of the audio signal being inputted to the signal processor 20 from the input 12. The detectors 31, 32, 33, 34, 35, 36 will generally be adapted to perform detection functionality on digital signals, so any audio signal inputs will generally be converted to digital prior to analysis by the input analyzer 30. However, in some embodiments, analog detection may be effectuated.

While the detectors 31, 32, 33, 34, 35, 36 are discussed separately from the input analyzer 30, it should be appreciated that each of the detectors 31, 32, 33, 34, 35, 36 will generally be incorporated into the input analyzer 30. For example, the signal processor 20 may be programmed to perform the functions of each of the detectors 31, 32, 33, 34, 35, 36. In some embodiments, the signal processor 20 may be adjusted to fine-tune detection such as by setting thresholds of detection and the like.

Exemplary detectors 31, 32, 33, 34, 35, 36 shown in the figures include a transient detector 31, level detector 32, articulation detector 33, tempo detector 34, polyphonic detector 35, and density detector 36. This list is in no manner exhaustive, as additional attributes could be detected by the input analyzer 30 in different embodiments to suit different applications. Different combinations of detectors 31, 32, 33, 34, 35, 36 may be utilized in different embodiments.

As shown in FIG. 5, an exemplary input analyzer 30 may comprise a transient detector 31. The transient detector 31 may be adapted to analyze the audio signal for instantaneous amplitude increases (transients). A transient is generally understood to be high amplitude, short-duration sound within a waveform such as at the beginning of a waveform. Transients may contain a high degree of non-periodic components and a higher magnitude of high frequencies than the harmonic content of the sound of the audio signal.

The transient detector 31 may also be adapted in some embodiments to detect timing of detected transients. The transients and their timing detected by the input analyzer 30 may be utilized by the signal processor 20 to determine which, if any, of the effects to be applied by the signal conditioner 40. By way of example, different delay lengths or reverberation times may be set by the signal processor 20 using the signal conditioner 40 to automatically adjust the audio signal in response to transient detection in real-time by the transient detector 31 of the input analyzer 30.

As shown in FIG. 5, an exemplary input analyzer 30 may comprise a level detector 32. The level detector 32 may be adapted to analyze the audio signal for changes in signal level. The level detector 32 preferably operates continuously in real-time to analyze the signal level of the audio signal at the input 12 of the signal processor 20. Various effects or modifications may be made to the audio signal by the signal conditioner 40 depending on detected signal levels by the level detector 32. For example, audio signal levels or other parameters downstream may be adjusted automatically in real-time by the signal conditioner 40 in response to the level detector 32 of the input analyzer 30.

As shown in FIG. 5, an exemplary input analyzer 30 may comprise an articulation detector 33. The articulation detector 33 may be adapted to analyze the audio signal for articulation detection. The articulation detector 33 preferably operates continuously in real-time to analyze the articulation of the audio signal at the input 12 of the signal processor 20. By way of example, the articulation detector 33 may be adapted to determine whether a performer 15 is playing with a smoother legato style or more percussively. The manner in which the articulation detector 33 detects articulation may vary, including the use of standard deviation techniques. Various effects or modifications may be made to the audio signal by the signal conditioner 40 depending on articulation detected by the articulation detector 33.

As shown in FIG. 5, an exemplary input analyzer 30 may comprise a tempo detector 34. The tempo detector 34 may be adapted to analyze the audio signal to estimate the effective tempo of the performance. The tempo detector 34 preferably operates continuously in real-time to analyze the audio signal at the input 12 of the signal processor 20 to estimate or determine effective tempo. The manner in which tempo is estimated may vary, including use of detected transient timings to determine effective tempo. Various effects or modifications may be made to the audio signal by the signal conditioner 40 depending on the effective tempo such that different effects may be applied for slow versus fast passages. As shown in FIG. 5, an exemplary input analyzer 30 may comprise a polyphonic detector 35. The polyphonic detector 35 may be adapted to analyze the audio signal to determine if the performer 15 is playing single note phrases or chordal passages. The polyphonic detector 35 preferably operates continuously in real-time to analyze the audio signal at the input 12 of the signal processor 20 to determine whether single notes or chordal passages are being played. The manner in which the polyphonic detector 35 differentiates between single notes and chordal passages may vary, including the use of auto-correlation or similar techniques. Various effects or modifications may be made to the audio signal by the signal conditioner 40 depending on whether single notes or chordal passages are being played at any given time.

As shown in FIG. 5, an exemplary input analyzer 30 may comprise a density detector 36. The density detector 36 may be adapted to analyze the audio signal to determine note density of the performance. The density detector 36 preferably operates continuously in real-time to analyze the audio signal at the input 12 of the signal processor 20 to determine note density. Generally, a performer 15 playing rapid sequences of notes would typically desire a less dense effects field to allow individual notes to be heard. A performer 15 playing a sparser passage may desire a need for more ambience. The manner in which the density detector 36 detects note density may vary in different embodiments. Various effects or modifications may be made to the audio signal by the signal conditioner 40 depending on note density at any given time.

The input analyzer 30 may also be adapted detect tonal makeup of the audio signal. Using a number of methods, such as Fast Fourier Transform (FFT), the input analyzer 30 may approximate the tessitura of the performance. Tonal makeup may then be utilized to determine which modification or effects are made to the audio signal by the signal conditioner 40.

### D. Signal Conditioners

As best shown in FIGS. 2-8, the signal processor 20 may include one or more signal conditioners 40 which are adapted to modify or apply effects to the audio signal based on attributes detected by the input analyzer 30. Input analysis by the input analyzer 30 is preferably performed in parallel with effect generation by the signal conditioner 40 continuously in real-time. Results of the input analysis by the input analyzer 30 may be used to inform and/or select which effects, if any, are to be applied by the signal conditioners 40.

As shown in FIGS. 4-8, the signal processor 20 may include one or more signal conditioners 40; each including different effects. FIG. 4 illustrates an exemplary embodiment including a first signal conditioner 40a, a second signal conditioner 40b, and a third signal conditioner 40c. It should be appreciated that more or less signal conditioners 40 could be utilized in different embodiments.

Each of the signal conditioners 40a, 40b, 40c shown in FIG. 4 may comprise different effects chains so that different signal conditioners 40a, 40b, 40c may be selected to apply different effects to the audio signal. Each of the signal conditioners 40a, 40b, 40c is shown as being in parallel with the input analyzer 30. FIG. 4 also illustrates interconnections of the various components; with solid lines representing audio signal path and dotted lines representing control paths from the input analyzer 30 to the signal conditioners 40 and other downstream processing modules.

Each of the signal conditioners 40 may include a different effects chain; with individual signal conditioners 40 being selected for application to the audio signal by the selector 60 in response to analysis of the audio signal by the input analyzer 30 continuously in real-time. A wide range of effects may be included in the signal conditioners, including but not limited to filters 41, limiters 42, compressors 43, noise gates 44, phase shifters 45, flanges 46, chorus 47, delay 48, echo 49, reverberation 51, pitch change 52, rotating speakers 53, and/or distortion 54. It should be appreciated that various other effects may be utilized, and this list is merely meant to be exemplary and not exhaustive. The combination of effects available for use by the signal processor 20 may vary in different embodiments to suit different performers 15 or types of instruments 17.

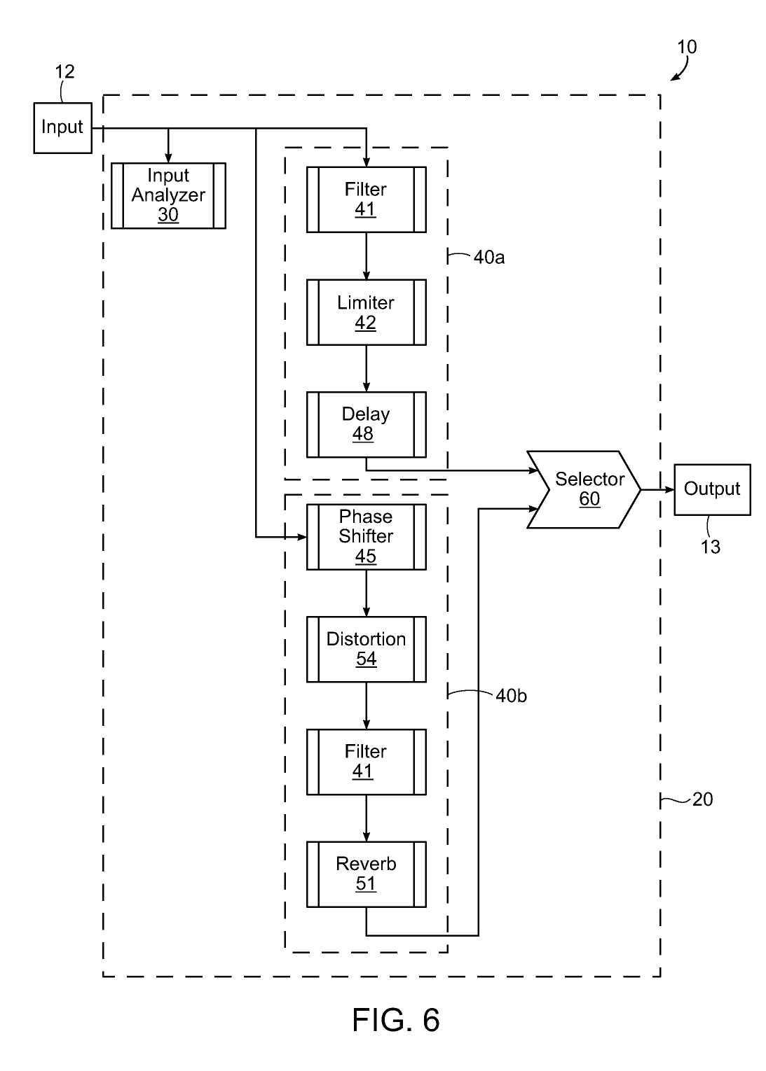

As shown in FIGS. 6-8, the signal conditioner 40 may include a filter 41 for adjusting various aspects of the audio signal. The filter 41 is typically utilized for equalization to balance between frequency components within the audio signal. By way of example and without limitation, the filter 41 may comprise a linear filter, all pass filter, high pass filter, low pass filter, band pass filter, notch filter, shelving filter, parametric filter, graphic filter, and the like.

Combinations of filters 41 may be utilized in certain embodiments to allow for additional options relating to equalization of the audio signal. The signal processor 20 may be preset to retain a certain equalization level; with filters 41 being applied to maintain the equalization level continuously in real-time while the instrument 17 is being played in response to certain attributes detected by the input analyzer 30.

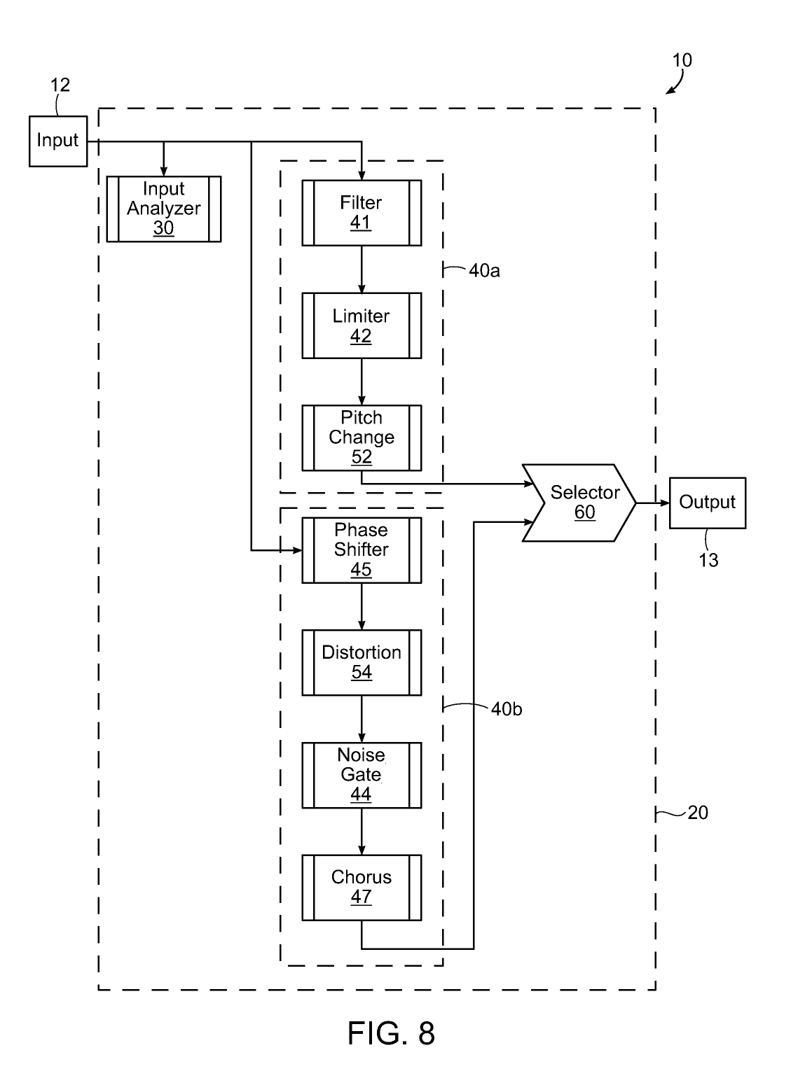

As shown in FIGS. 6 and 8, the signal conditioner 40 may include a limiter 42 or compressor 43 for adjusting various attributes of the audio signal. By way of example, a limiter 42 or compressor 43 may be used to provide dynamic range compression of the audio signal so as to reduce the dynamic range between the loudest and quietest parts of the audio signal.

For example, the quieter portions of the audio signal may be boosted while the louder portions of the audio signal are attenuated. The compression ratio of the limiter 42 or compressor 43 may vary and in some embodiments may be preset. In other embodiments, the ratio may be adjusted continuously in real-time by the signal processor 20 in response to detected attributes of the audio signal by the input analyzer 30.

As shown in FIG. 8, the signal conditioner 40 may include a noise gate 44 for automatically quieting the audio signal below a configurable threshold. The noise gate 44 will generally be adapted to attenuate portions of the audio signal that register below a threshold. In some embodiments, the threshold of the noise gate 44 may be automatically and continuously adjusted in real-time by the signal processor 20 in response to detected attributes of the audio signal by the input analyzer 30.

As shown in FIG. 8, the signal conditioner 40 may include a phase shifter 45, which is also commonly referred to as “phasing”. A phase shifter 45 may be effectuated by using a sequence of all-pass filters and mixing the resulting signal with the original audio signal, and then changing the center frequency of the all-pass filters so as to create a sweeping effect in the audio signal at the output 13. The phase shifter 45 may in some embodiments utilize notch and boost filters to phase-shift frequencies over time. The level of sweeping effects applied to the audio signal by the phase shifter 45 may be automatically and continuously adjusted in real-time by the signal processor 20 in response to detected attributes of the audio signal by the input analyzer 30.

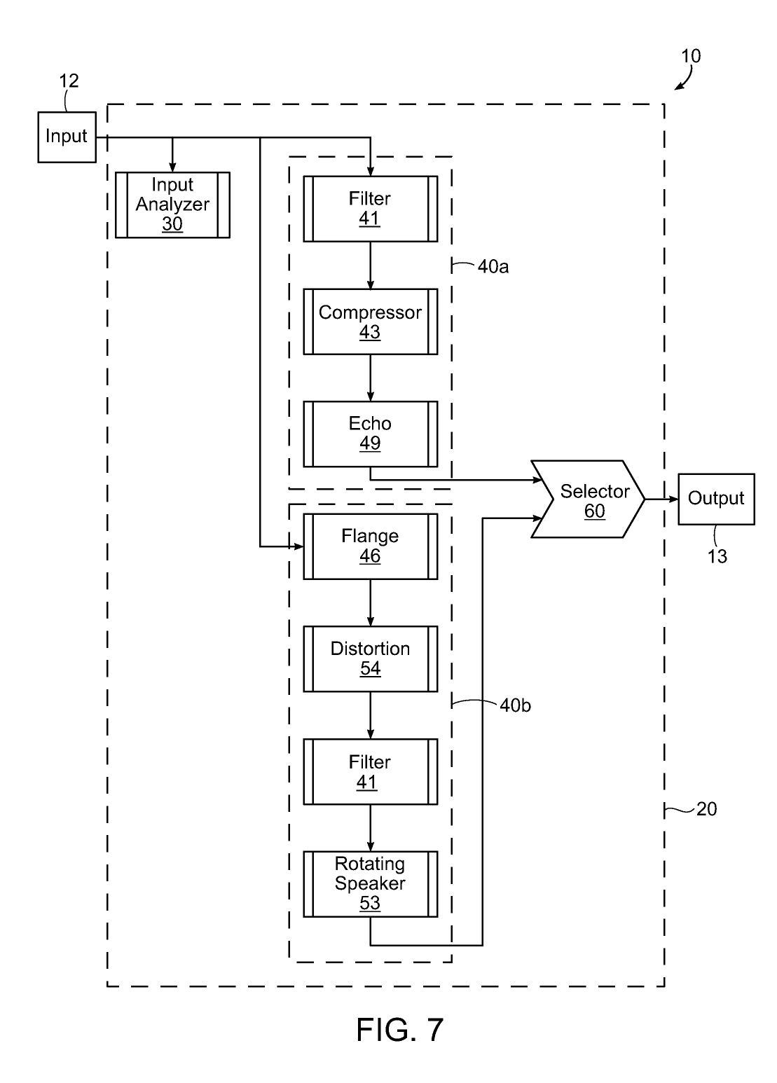

As shown in FIG. 7, the signal conditioner 40 may include a flange 46. The flange 46 may mix a short delay with the original audio signal to create a flanging effect. The length of delay may vary. By way of example, a 1-12 millisecond delay may be mixed with the original audio signal by the flange 46 to produce the flanging effect. The amount of delay applied to the mixed signal by the flange 46 may be automatically and continuously adjusted in real-time by the signal processor 20 in response to detected attributes of the audio signal by the input analyzer 30.

As shown in FIG. 8, the signal conditioner 40 may include a chorus 47. The chorus 47 may mix a longer delay than a flange 46 with the original audio signal to create a chorus effect. The length of delay may vary. By way of example, a 20-60 millisecond delay may be mixed with the original audio signal by the chorus 47 to produce the chorus effect. The amount of delay applied to the mixed signal by the chorus 47 may be automatically and continuously adjusted in real-time by the signal processor 20 in response to detected attributes of the audio signal by the input analyzer 30.

As shown in FIGS. 6-7, the signal conditioner 40 may include a delay 48 and/or echo 49 effect. A delay 48 effect postpones the audio signal from playing for a period of time, creating a single instance of the source sound being repeated once. An echo 49 effect is similar, except that the delayed sound is repeated multiple times. While a delay 48 provides a one-time replication of the audio signal at a delay (generally in the milliseconds range), echo 49 provides multiple repeated replications of the audio signal at a delay.

Delay 48 and echo 49 effects are generally defined by the period of time of the delayed playing of the replicated sound. This period of time may be preset by the performer 15 or, may be automatically adjusted continuously n real-time by the signal processor 20 in response to detected attributes of the audio signal by the input analyzer 30. For example, passages of performances which have different tempos would benefit from automatic adjustment of the period of time for delay 48 and/or echo 49 effects. Various types of delay 48 and echo 49 effects may be provided in the signal conditioner 40, such as but not limited to ping pong, tap, slap, and doubling effects.

As shown in FIG. 6, the signal conditioner 40 may include a reverb 51 effect. A reverb 51 effect is a type of delayed effect in which sounds may be made to sound fuller by allowing the sound to reverberate. The magnitude and other characteristics of the reverb 51 effect may be automatically and continuously adjusted in real-time by the signal processor 20 in response to detected attributes of the audio signal by the input analyzer 30.

As shown in FIG. 8, the signal conditioner 40 may include a pitch change 52 effect, also commonly referred to as pitch shifting. A pitch change 52 effect raises or lowers the original pitch of the audio signal. The amplitude of the pitch change is generally defined by preset intervals. The pitch change 52 effect may be accomplished by various methods, including but not limited to use of a Fast Fourier Transform (FFT) to create a copy of the audio signal with a specific pitch shift applied. This pitch-shifted audio signal may be combined with the original audio signal or may be played in isolation. The intervals and timing of the pitch change 52 effect may be automatically and continuously adjusted in real-time by the signal processor 20 in response to detected attributes of the audio signal by the input analyzer 30.

As shown in FIG. 7, the signal conditioner 40 may include a rotating speaker 52 effect. A rotating speaker 52 effect may use a combination of delay, volume, and tone undulations to simulate a rotating speaker, such as the popular Leslie speaker known in the art. The characteristics of the undulations to create the rotating speaker effect may be automatically and continuously adjusted in real-time by the signal processor 20 in response to detected attributes of the audio signal by the input analyzer 30.

As shown in FIG. 8, the signal conditioner 40 may include a distortion 54 effect. Distortion 54 effects generally increase the gain of an audio signal to produce a fuzzy or gritty tone as is common in rock and blues music. Distortion is generally defined by the amount of gain being applied. The amount of gain applied at any given time may be automatically and continuously adjusted in real-time by the signal processor 20 in response to detected attributes of the audio signal by the input analyzer 30.

As shown in FIG. 5, the signal conditioners 40 are generally in parallel with the input analyzers 30 to prevent clicking or other delays in application of effects based on changing attributes of the audio signal. The signal conditioners 40 may also be in parallel with each other so that they may be switched between as needed based on the audio signal.

### E. Operation of Preferred Embodiment

The dynamic audio signal processing system 10 may be adapted to dynamically configure a digital signal processing chain based on input signal characteristics. A musical performance, such as from a guitar, can be analyzed and attributes extracted to allow automatic and dynamic configuration of downstream musical effects. The effects chain may be dynamically adapted to the musical performance, giving the performer 15 an additional component of control over their performance. The performer 15 may thus experience a significant increase in expression controlling soundscapes solely from their instrument 17, without the need for additional external controllers.

The signal processor 20 will preferably have the bandwidth to perform the various types of input detection discussed to determine various attributes of the audio signal by the input analyzer 30. By performing this analysis in real-time and applying the results to the signal conditioners 40, the performer 15 may incorporate additional elements into their performance resulting in a greater variety of sounds, expressiveness, tonal colorings, and textures than would have previously been possible without a dedicated sound engineer and the non-real-time setting of a recording studio or the like.

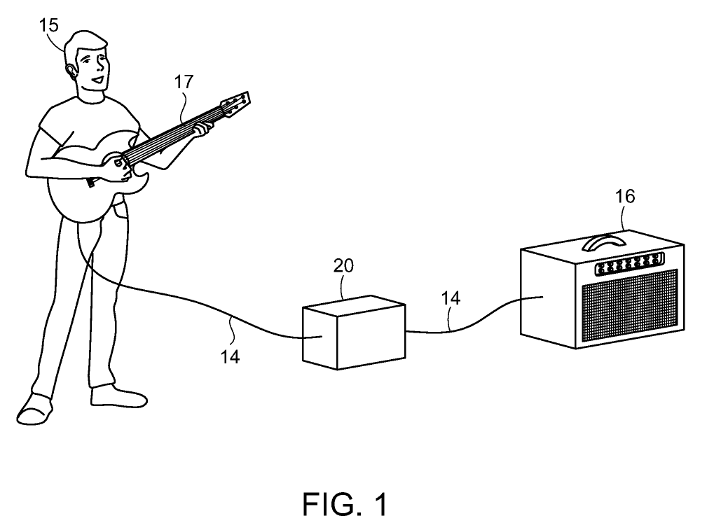

In use, an audio signal will generally be received by the input 12 of the signal processor 20. The source of the audio signal may vary in different embodiments. For example, the audio signal could come from an instrument 17 such as a guitar by plugging the instrument 17 directly into the input 12 of the signal processor 20, such as with a cord 14 as shown in FIG. 1. In other embodiments, a microphone (not shown) may be positioned near an output of the instrument. The microphone may be connected to the input 12 of the signal processor 20. In such an embodiment, the signal processor 20 may include an analog-to-digital converter to convert an analog audio signal into a digital audio signal for detection and processing.

The output 13 of the signal processor 20 may be connected to a device such as a speaker for playing the processed audio signal or to a recording device or the like. Alternatively, the output 13 of the signal processor 20 may be connected to other devices for further processing, or to a recording device to be recorded for future playing. The output 13 may be connected by a cord 14 as shown in FIG. 1, or may be wirelessly connected in some embodiments.

As the instrument 17 is played by the performer 15, the signal processor 20 will continuously and in real-time detect various attributes of the audio signal using the input analyzer 30. The input analyzer 30 may be adapted to detect a wide range of attributes, such as but not limited to transients, transient timing, signal level, articulation, tempo, single notes, chordal phrases, note density, and the like.

The signal conditioners 40 are in parallel with the input analyzer 30 to effectuate dynamic and continuous effects applications without clicking or other undesirable effects. Where multiple signal conditioners 40 are utilized, the selector 60 of the signal processor 20 will continuously query the input analyzer 30 for various attributes of the audio signal and, in response to the detected attributes, select one (or none) of the signal conditioners 40 to apply effects to the audio signal. For example, on slower passages having single notes, a first signal conditioner 40 could be applied to the audio signal. On faster passages having chordal phrases, a second signal conditioner 40 could be applied to the audio signal.

Both the detection and application of effects is continuously performed by the signal processor 20 in real-time. The application of effects may be dynamic, with characteristics of the effects being applied capable of being altered by the signal conditioner 40 based on detected attributes by the input analyzer 30. For example, a delay 48 effect may be dynamically adjusted by the signal processor 20 in response to detected tempo changes by the tempo detector 34 of the input analyzer 30.

FIGS. 6-8 illustrate exemplary signal conditioners 40 for use with the methods and systems described herein. Each signal conditioner 40 may comprise one effect, or may comprise multiple effects which are grouped together to create a certain desired soundscape. In systems with multiple signal conditioners 40, the signal processor 20 may include a selector 60 which is adapted to continuously and automatically select which of the signal conditioners 40 to apply to the audio signal depending on the detected attributes of the audio signal by the input analyzer.

FIG. 6 illustrates a first exemplary embodiment in which an input analyzer 30 is connected in parallel with a first signal conditioner 40a and a second signal conditioner 40b. The first signal conditioner 40a is illustrated as comprising a filter 41, limiter 42, and delay 48. The second signal conditioner 40b is illustrated as comprising a phase shifter 45, distortion 54, filter 41, and reverb 51. As the input analyzer 30 continuously detects various attributes of the audio signal in real-time, the selector 60 will automatically apply either (or none) of the signal conditioners 40a, 40b to the audio signal based on the detected attributes of the audio signal. Further, the amount of each effect being applied may also be controlled by the signal processor 20 in real-time, such as changing the period of delay depending on the tempo of the particular passage being played or applying distortion 54 based on the articulation of the audio signal as detected by the articulation detector 33 of the input analyzer 30.

Continuing to reference FIG. 6, louder performance passages may select the second signal conditioner 40b which would be more suitable for solos. More restrained passages may select the first signal conditioner 40a which would be more appropriate for slower chording. The interval of the delay 48 effect being applied could be informed by the transient detection performed by the transient detector 31 of the input analyzer 30.

FIG. 7 illustrates a second exemplary embodiment in which an input analyzer 30 is connected in parallel with a first signal conditioner 40a and a second signal conditioner 40b. The first signal conditioner 40a is illustrated as comprising a filter 41, compressor 43, and echo 49 effect. The second signal conditioner 40b is illustrated as comprising a flange 46, distortion 54, filter 41, and rotating speaker 53. As the input analyzer 30 continuously detects various attributes of the audio signal in real-time, the selector 60 will automatically apply either (or none) of the signal conditioners 40a, 40b to the audio signal based on the detected attributes of the audio signal. The amount of each effect, such as the amount of gain for distortion 54 or the delay periods for the echo 49 may also be controlled by the signal processor 20 in real-time.

FIG. 8 illustrates a third exemplary embodiment in which an input analyzer 30 is connected in parallel with a first signal conditioner 40a and a second signal conditioner 40b. The first signal conditioner 40a is illustrated as comprising a filter 41, limiter 42, and pitch change 52 effect. The second signal conditioner 40b is illustrated as comprising a phase shifter 45, distortion 54, noise gate 44, and chorus 47. As the input analyzer 30 continuously detects various attributes of the audio signal in real-time, the selector 60 will automatically apply either (or none) of the signal conditioners 40a, 40b to the audio signal based on the detected attributes of the audio signal. The amount of each effect, such as the period of time delay for the chorus 47, may also be controlled by the signal processor 20 in real-time.

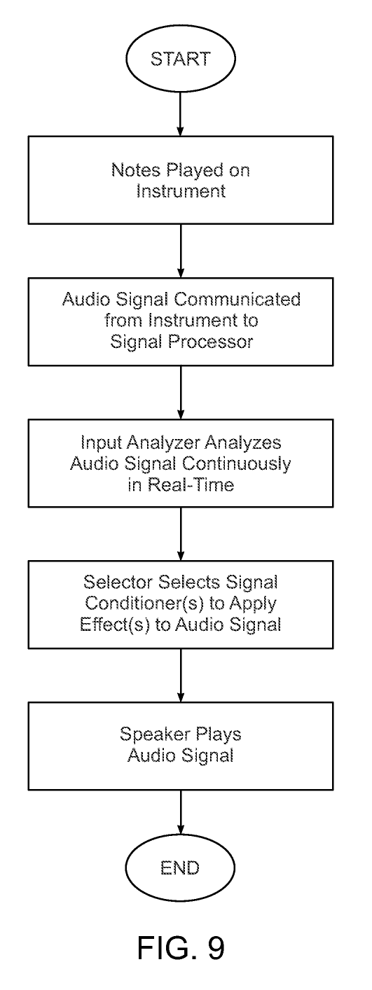

FIGS. 9-17 illustrate various methods of automatically and continuously applying effects to an audio signal in real-time based on detected attributes of the audio signal. As shown in FIG. 9, notes may be played on an instrument 17. An audio signal from the instrument 17 is communicated to the signal processor 20. The input analyzer 30 analyzes the audio signal continuously in real-time while the selector 60 selects signal conditioner(s) 40 to apply effect(s) to the audio signal. The speaker 16 plays the modified audio signal. All of these steps are continuously repeated in real-time to effectuate a smooth sound without clicking between effects.

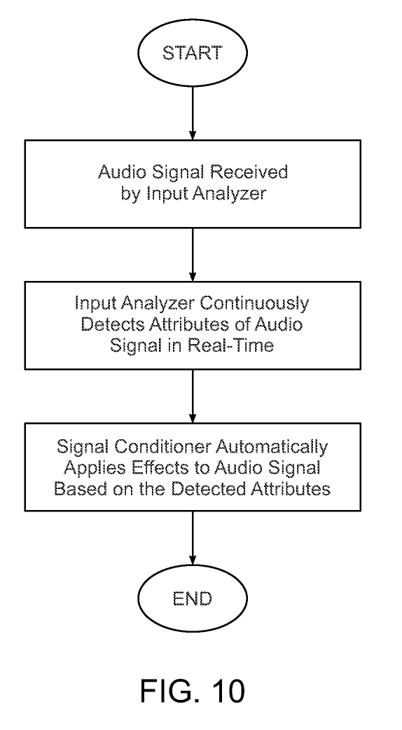

FIG. 10 illustrates a method of analyzing the audio signal. As shown, the audio signal is received by the input analyzer 30. The input analyzer 30 continuously detects attributes of the audio signal in real-time while the signal conditioner 40 automatically applies effects to the audio signal based on the detected attributes.

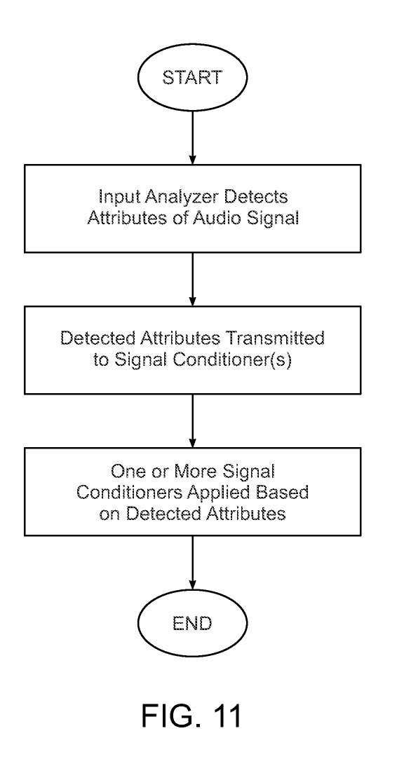

FIG. 11 illustrates a method of applying effects to the audio signal. As shown, the input analyzer 30 detects attributes of the audio signal. Detected attributes are automatically transmitted to the signal conditioner 40. One or more signal conditioners 40 may be applied to the audio signal based on detected attributes continuously in real-time.

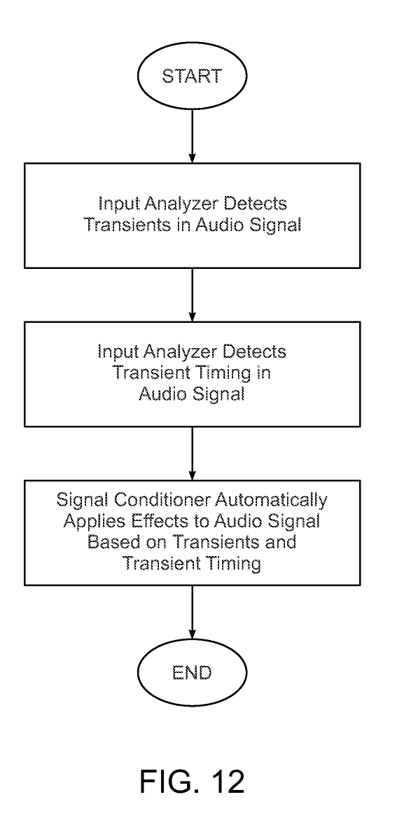

FIG. 12 illustrates a method of transient detection by the transient detector 31 of the input analyzer 30. The input analyzer 30 detects transients in the audio signal. The input analyzer 30 may also detect timing between transients in the audio signal. The signal conditioner 40 automatically applies effects to the audio signal based on the detected transients and transient timing by the transient detector 31.

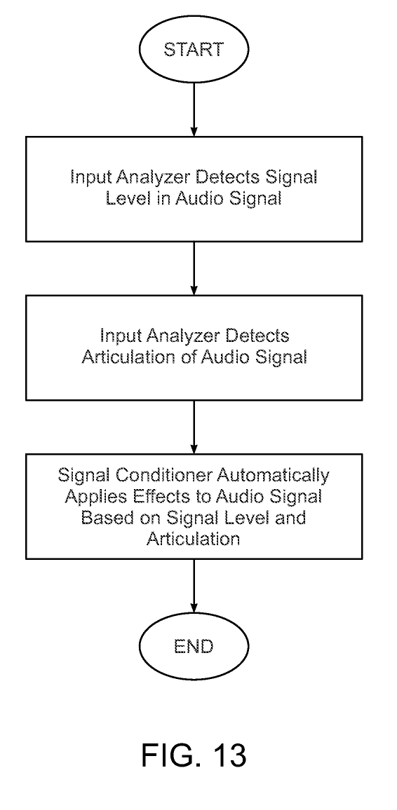

FIG. 13 illustrates a method of articulation and signal level detection by the articulation detector 33 and level detector 32 of the input analyzer 30. The level detector 32 of the input analyzer 30 detects signal level in the audio signal. At the same time and in parallel, the articulation detector 33 of the input analyzer 30 detects articulation of the audio signal. The signal conditioner 40 automatically applies effects to the audio signal based on signal level and articulation as detected by the level and articulation detectors 32, 33 continuously in real-time.

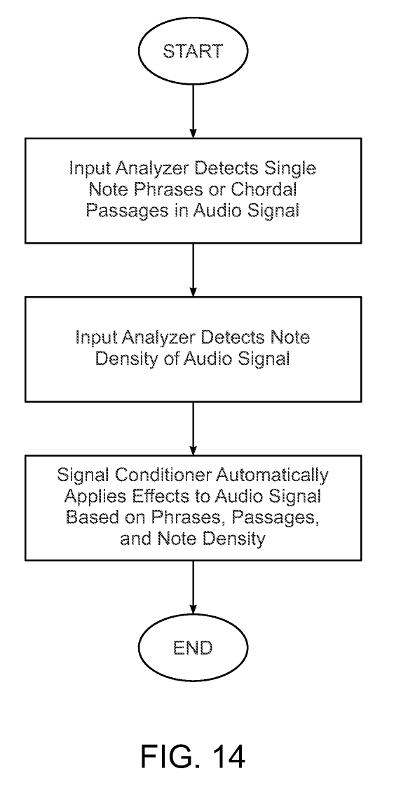

FIG. 14 illustrates a method of polyphonic and density detection by the polyphonic detector 35 and density detector 36 of the input analyzer 30. The input analyzer 30 detects single note phrases or chordal passages in the audio signal using the polyphonic detector 35. At the same time and in parallel, the input analyzer 30 detects note density of the audio signal using the density detector 36. The signal conditioner 40 automatically applies effects to the audio signal based on phrases, passages, and note density as detected by the polyphonic and density detectors 35, 36 continuously in real-time.

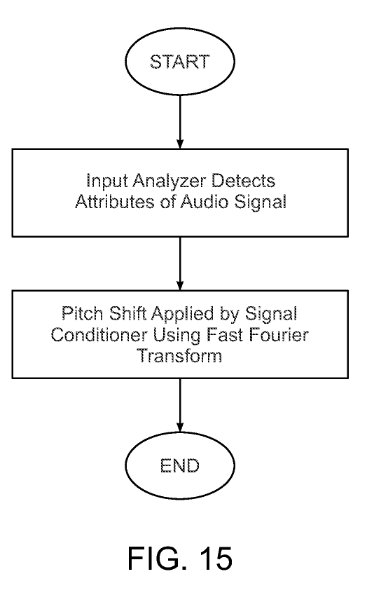

FIG. 15 illustrates a method of applying a pitch shift to the audio signal. The input analyzer 30 detects attributes of the audio signal. A pitch shift may then be applied by the pitch change 52 effect of the signal conditioner 40 using Fast Fourier Transform (FFT) or other techniques. Both the analysis and signal conditioning occur in parallel continuously in real-time to prevent any clicks or the like.

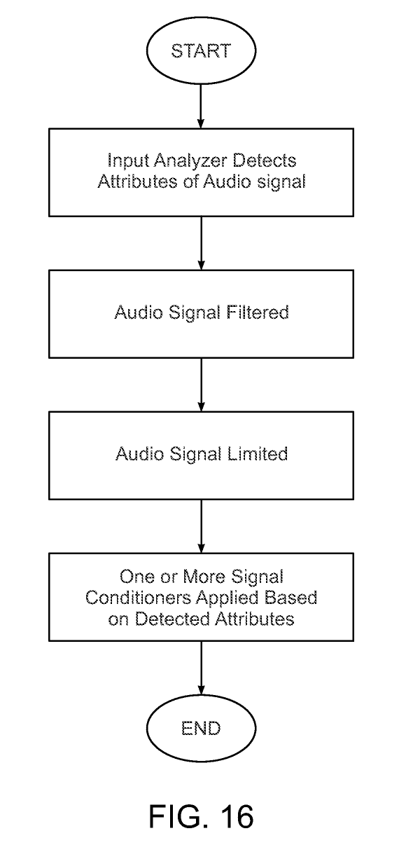

FIG. 16 illustrates a method of signal conditioning which utilizes a filter 41 and limiter 42. The input analyzer 30 detects attributes of the audio signal. The audio signal is filtered by a filter 41 and limited by a limiter 42. One or more signal conditioners 40 may be applied dynamically in real-time based on the detected attributes of the input analyzer 30.

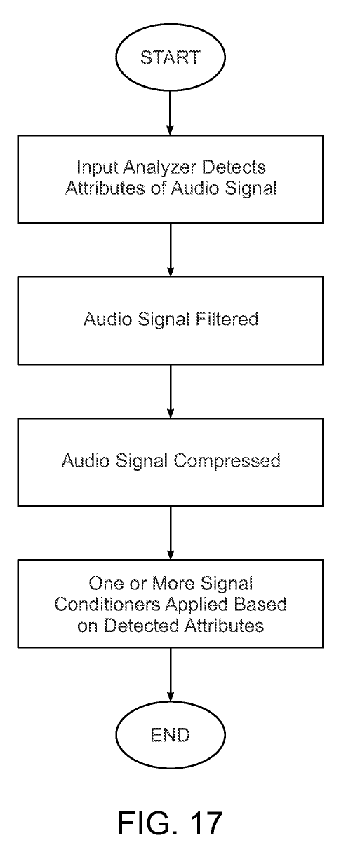

FIG. 17 illustrates a method of signal conditioning which utilizes a filter 41 and compressor 43. The input analyzer 30 detects attributes of the audio signal. The audio signal is filtered by a filter 41 and compressed by a compressor 43. One or more signal conditioners 40 are then applied based on the detected attributes dynamically in real-time.

Unless otherwise defined, all technical and scientific terms used herein have the same meaning as commonly understood by one of ordinary skill in the art to which this invention belongs. Although methods and materials similar to or equivalent to those described herein can be used in the practice or testing of the dynamic audio signal processing system, suitable methods and materials are described above. All publications, patent applications, patents, and other references mentioned herein are incorporated by reference in their entirety to the extent allowed by applicable law and regulations. The dynamic audio signal processing system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. An audio signal processing system, comprising:
an input adapted to receive an audio signal;
a signal processor adapted to process the audio signal;
an input analyzer for analyzing the audio signal, wherein the input analyzer is adapted to continuously detect one or more attributes of the audio signal in real-time; and
a signal conditioner adapted to automatically apply one or more effects to the audio signal based on the one or more attributes detected by the input analyzer.

2. The audio signal processing system of claim 1, wherein the input analyzer comprises a transient detector for detecting transients in the audio signal.

3. The audio signal processing system of claim 2, wherein the transient detector is adapted to detect transient timing of the audio signal.

4. The audio signal processing system of claim 1, wherein the input analyzer comprises a level detector for detecting changes in a signal level of the audio signal.

5. The audio signal processing system of claim 1, wherein the input analyzer comprises an articulation detector for detecting an articulation of the audio signal.

6. The audio signal processing system of claim 5, wherein the articulation detector is adapted to detect whether the audio signal is legato or staccato.

7. The audio signal processing system of claim 1, wherein the input analyzer comprises a tempo detector for detecting a tempo of the audio signal.

8. The audio signal processing system of claim 1, wherein the input analyzer comprises a polyphonic detector for detecting whether the audio signal comprises single note phrases or chordal passages.

9. The audio signal processing system of claim 1, wherein the input analyzer comprises a density detector for detecting a note density of the audio signal.

10. The audio signal processing system of claim 1, wherein the one or more effects is selected from the group consisting of a phase shifter, a flange, a chorus, a delay, an echo, a reverb, a pitch change, a rotating speaker, and a distortion.

11. The audio signal processing system of claim 1, comprising a selector adapted to select which of the one or more effects to be applied to the audio signal.

12. An audio signal processing system, comprising:
an instrument for producing an audio signal;
a signal processor including an input adapted to receive the audio signal;
an input analyzer for analyzing the audio signal, wherein the input analyzer is adapted to continuously detect one or more attributes of the audio signal in real-time;
a signal conditioner for automatically applying one or more of a plurality of effects to the audio signal based on the one or more attributes detected by the input analyzer;
a selector adapted to select which of the plurality of effects to be applied to the audio signal; and
a speaker connected to an output of the signal processor for playing the audio signal after the plurality of effects have been applied to the audio signal.

13. The audio signal processing system of claim 12, wherein the input analyzer comprises a transient detector for detecting transients in the audio signal and a level detector for detecting changes in a signal level of the audio signal.

14. The audio signal processing system of claim 13, wherein the plurality of effects is selected from a group consisting of a phase shifter, a flange, a chorus, a delay, an echo, a reverb, a pitch change, a rotating speaker, and a distortion.

15. The audio signal processing system of claim 14, wherein the input analyzer comprises:
an articulation detector for detecting an articulation of the audio signal;
a tempo estimator for estimating a tempo of the audio signal;
a polyphonic detector for detecting whether the audio signal comprises single note phrases or chordal passages; and
a density detector for detecting a note density of the audio signal.

16. A method of processing an audio signal, comprising:
receiving an audio signal by an input of a signal processor;
analyzing the audio signal by an input analyzer of the signal processor continuously in real-time to detect one or more attributes of the audio signal; and
applying one or more effects to the audio signal by one or more signal conditioners of the signal processor continuously in real-time based on the one or more attributes detected by the input analyzer.

17. The method of claim 16, wherein the one or more effects is selected from the group consisting of a phase shifter, a flange, a chorus, a delay, an echo, a reverb, a pitch change, a rotating speaker, and a distortion.

18. The method of claim 17, wherein the one or more attributes is selected from the group consisting of transients, transient timing, signal level, articulation, tempo, and note density.

19. The method of claim 16, comprising the step of modifying the one or more effects applied to the audio signal by the signal processor continuously in real-time based on the one or more attributes detected by the input analyzer.

20. The method of claim 16, wherein the input analyzer is selected from the group consisting of a transient detector, a level detector, an articulation detector, a tempo detector, a polyphonic detector, and a density detector.
